(19) United States
(12) Patent Application Publication
(10) Pub. No.: US 2025/0035488 A1
(43) Pub. Date: Jan. 30, 2025

(54) PRINTING SYSTEM, COLORIMETRY CONTROL METHOD, AND STORAGE MEDIUM

(71) Applicant: Konica Minolta, Inc., Tokyo (JP)

(72) Inventor: Hiroyuki OOYAMA, Tokyo (JP)

(73) Assignee: Konica Minolta, Inc., Tokyo (JP)

(21) Appl. No.: 18/776,914

(22) Filed: Jul. 18, 2024

(30) Foreign Application Priority Data
Jul. 27, 2023 (JP) 2023-122080

(51) Int. Cl. G01J 3/46; H04N 1/60

(52) U.S. Cl. CPC G01J 3/462; H04N 1/6041; H04N 2201/0082

(57) ABSTRACT

A printing system includes a printing section, a colorimetry unit capable of colorimetry on an entire surface of a print product printed by the printing section, and a hardware processor that performs color adjustment on the printing section based on a colorimetry result by the colorimetry unit. The hardware processor, in response to a predetermined area in first image data to be printed satisfying a colorimetry area condition of the colorimetry unit, causes the colorimetry unit to perform colorimetry in a first mode, and in response to the predetermined area not satisfying the colorimetry area condition, causes the colorimetry unit to perform colorimetry in a second mode.

### CROSS-REFERENCE TO RELATED APPLICATIONS

This application claims priority to Japanese Patent Application No. 2023-122080, filed on Jul. 27, 2023, the entire contents of which are incorporated herein by reference.

### BACKGROUND OF THE INVENTION

### Technical Field

The present invention relates to a printing system, a colorimetry control method, and a storage medium.

### Description of Related Art

In a printing apparatus, the density, the tint or the like of an output image changes due to temporal change or environmental change. Therefore, it is necessary to perform color adjustment according to the current printing state. Color adjustment is, for example, a process of measuring the color of (performing colorimetry on) a print product printed by a printing apparatus, comparing the colorimetry result with a target color, and setting a condition(s) for printing an output image with appropriate tint. In particular, there is a strong demand for spot colors to be printed with correct tint.

As one of the color adjustment methods, there is a method in which patch images in multiple colors (dedicated chart for color adjustment) are printed by a printing apparatus, and the colors of the patch images are measured to perform color adjustment. Since this method does not measure the color of a print product to be finally output, the influence of in-plane unevenness which may occur in an actual print product is not considered.

To deal with this, an information processing apparatus that performs colorimetry and color adjustment on a colorimetry area set in an image to be formed with image data has been proposed (see Japanese Unexamined Patent Publication No. 2022-162412). In this information processing apparatus, in the automatic mode, the colorimetry area is automatically extracted on condition that the area has a color value variation equal to or smaller than a predetermined value and a size equal to or larger than a predetermined size. On the other hand, in the manual mode, the colorimetry area is specified by the user.

### SUMMARY OF THE INVENTION

However, the above-described conventional technique does not refer to a case where the colorimetry area is smaller than a predetermined size. Therefore, if an area having a size smaller than a predetermined size is specified as a colorimetry area, there is a problem that colorimetry cannot be performed on the colorimetry area and color adjustment cannot be performed.

Thus, in colorimetry, there is a colorimetry area condition such as the size of the colorimetry area being “equal to or larger than a predetermined size”. The area specified by the user in the image data to be printed does not always satisfy the colorimetry area condition. If colorimetry is performed without the colorimetry area condition being satisfied, a noise component is included in the colorimetry result due to the influence of a color adjacent to the color of the color adjustment target or the like, and thus it is likely that the color adjustment cannot be accurately performed.

The present invention has been made in consideration of the above-described problem in the conventional technique, and objects of the present invention include accurately performing color adjustment even if the colorimetry area condition is not satisfied.

To achieve at least one of the abovementioned objects, according to an aspect of the present invention, a printing system reflecting one aspect of the present invention includes:
a printing section;
a colorimetry unit capable of colorimetry on an entire surface of a print product printed by the printing section; and
a hardware processor that performs color adjustment on the printing section based on a colorimetry result by the colorimetry unit,
wherein the hardware processor,
   in response to a predetermined area in first image data to be printed satisfying a colorimetry area condition of the colorimetry unit, causes the colorimetry unit to perform colorimetry in a first mode, and
   in response to the predetermined area not satisfying the colorimetry area condition, causes the colorimetry unit to perform colorimetry in a second mode.

According to an aspect of the present invention, a colorimetry control method reflecting one aspect of the present invention is performed by a computer of a printing system including a printing section and a colorimetry unit capable of colorimetry on an entire surface of a print product printed by the printing section, the computer performing color adjustment on the printing section based on a colorimetry result by the colorimetry unit, and includes:
in response to a predetermined area in first image data to be printed satisfying a colorimetry area condition of the colorimetry unit, causing the colorimetry unit to perform colorimetry in a first mode, and
in response to the predetermined area not satisfying the colorimetry area condition, causing the colorimetry unit to perform colorimetry in a second mode.

According to an aspect of the present invention, a non-transitory computer-readable storage medium reflecting one aspect of the present invention stores a program that causes a computer of a printing system including a printing section and a colorimetry unit capable of colorimetry on an entire surface of a print product printed by the printing section, the computer performing color adjustment on the printing section based on a colorimetry result by the colorimetry unit, to perform:
in response to a predetermined area in first image data to be printed satisfying a colorimetry area condition of the colorimetry unit, causing the colorimetry unit to perform colorimetry in a first mode; and
in response to the predetermined area not satisfying the colorimetry area condition, causing the colorimetry unit to perform colorimetry in a second mode.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a system configuration of a printing system and a functional configuration of each device in the printing system according to an embodiment of the present invention;

FIG. 2 is a flowchart showing a color adjustment process;

FIG. 3 is a flowchart showing the color adjustment process;

FIG. 4 shows an example of an automatic extraction result presentation screen;

FIG. 5 shows an example of a colorimetry area specification screen;

FIG. 6 shows an example of a colorimetry method selection screen;

FIG. 7 shows an example of third image data obtained by enlarging image data to be printed;

FIG. 8 shows an example of second image data in which patch images are added to margin portions of the image data to be printed; and

FIG. 9 shows an example of second image data in which a patch image is added to the same position as a specified area of the image data to be printed.

### DETAILED DESCRIPTION

Hereinafter, embodiments of a printing system, a colorimetry control method, and a storage medium storing a program according to the present invention will be described with reference to the drawings. However, the present invention is not limited to the embodiments or illustrated examples.

### [Configuration of Printing System]

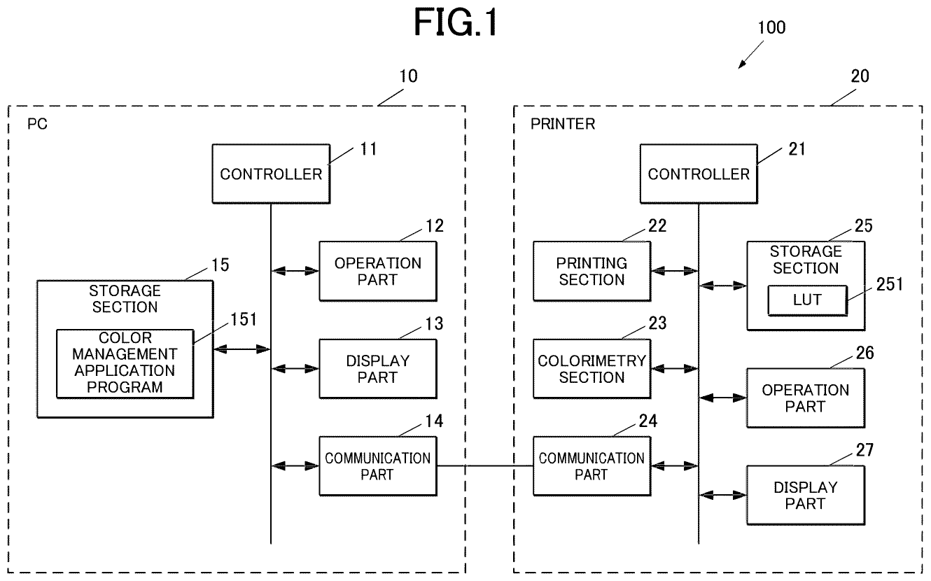

FIG. 1 shows a system configuration of a printing system 100 and a functional configuration of each device in the printing system 100 according to the present embodiment. The printing system 100 includes a personal computer (PC) 10 and a printer 20.

The PC 10 is used by an operator or the like who performs color management or printing work at a printing company or the like that owns the printer 20.

The printer 20 performs printing on a sheet on the basis of image data transmitted from the PC 10.

The PC 10 includes a controller 11 (hardware processor), an operation part 12, a display part 13, a communication part 14, a storage section 15, and the like. The components constituting the PC 10 are connected by a bus.

The controller 11 includes a central processing unit (CPU), a random access memory (RAM), and the like. The controller 11 comprehensively controls processing operation of the components of the PC 10. Specifically, the CPU reads various programs stored in the storage section 15, loads the programs to the RAM, and performs various processes in cooperation with the programs.

The operation part 12 includes a keyboard, a mouse, and the like. The operation part 12 receives an operation input by a user. The keyboard includes cursor keys, character input keys, number input keys, and various function keys. The operation part 12 outputs, to the controller 11, operation signals input by key operations on the keyboard and mouse operations.

The operation part 12 may include a touch screen laminated on the display part 13. In this case, the operation part 12 receives a user input on the display screen and outputs, to the controller 11, an operation signal corresponding to the position of the touch operation.

The display part 13 includes a monitor such as a liquid crystal display (LCD). The display part 13 displays various screens in accordance with instructions of display signals input from the controller 11.

The communication part 14 is configured by a network interface or the like. The communication part 14 transmits and receives data to and from an external device connected via a communication network such as a local area network (LAN) or a wide area network (WAN). Note that the PC 10 and the printer 20 may be connected by a dedicated cable.

The storage section 15 includes a hard disk drive (HDD), a nonvolatile semiconductor memory, and the like. The storage section 15 stores various programs, data necessary for executing the programs, and the like. For example, the storage section 15 stores a color management application program 151 for performing color management.

The color management application provided by executing the color management application program 151 performs the following processes (1) to (6) and the like:
(1) Process of identifying a predetermined area in which a color of a spot color is used, in image data to be printed
(2) Process of determining whether the predetermined area satisfies a colorimetry area condition
(3) Process of generating alternative image data from the image data to be printed if the predetermined area does not satisfy the colorimetry area condition
(4) Printing control process of an image for color adjustment (image data to be printed or alternative image data)
(5) Colorimetry control process of the image for color adjustment
(6) Color adjustment process (update of LUT 251 stored in the printer 20)

The printer 20 includes a controller 21, a printing section 22, a colorimetry section 23, a communication part 24, a storage section 25, an operation part 26, a display part 27, and the like. The components constituting the printer 20 are connected by a bus.

The controller 21 includes a CPU, a RAM, and the like. The controller 21 comprehensively controls the processing operation of the components of the printer 20. Specifically, the CPU reads various programs stored in the storage section 25, loads the programs to the RAM, and performs various processes in cooperation with the programs.

The printing section 22 performs printing on a sheet with color materials (toner, ink, and the like) of four color components (process colors) of cyan (C), magenta (M), yellow (Y), and black (K). A printing method of the printing section 22 is not particularly limited, and may be an electrophotographic method, an inkjet method, or the like.

The colorimetry section 23 (colorimetry unit) performs colorimetry on (i.e., measures the color of) a print product printed by the printing section 22 and generates colorimetry data. The colorimetry section 23 is provided on a conveyance path of a sheet, and can measure the color of a print product being conveyed. The colorimetry section 23 is configured to be movable with respect to a print product in a direction (main scanning direction) orthogonal to a conveyance direction (sub-scanning direction) of a print product. The colorimetry section 23 can measure the color of the entire surface of the print product in accordance with the timing at which the print product is conveyed thereto and the position of the colorimetry section 23 in the main scanning direction.

The colorimetry section 23 can measure the color of a colorimetry target area of a print product.

Information on the colorimetry target area is transmitted from the PC 10 to the printer 20.

The communication part 24 is configured by a network interface or the like. The communication part 24 transmits and receives data to and from an external device connected via a communication network such as a LAN or a WAN.

The storage section 25 includes an HDD, a nonvolatile semiconductor memory, and the like. The storage section 25 stores various programs, data necessary for executing the programs, and the like. For example, a lookup table (LUT) 251 is stored in the storage section 25. The LUT 251 is a lookup table (spot color table) in which a combination of color components (CMYK values) is associated with each spot color to be output when the color to be printed is specified by a spot color.

The operation part 26 includes various function keys and a touch screen. The operation part 26 receives an operation input by a user. The operation part 26 outputs, to the controller 21, operation signals input by operating the various function keys and the touch screen.

The display part 27 includes an LCD and the like. The display part 27 displays various screens in accordance with instructions of display signals input from the controller 21.

The controller 11 of the PC 10 causes the printing section 22 to print the color adjustment image (image data to be printed or alternative image data). Examples of the alternative image data include second image data (patch-added image data) and third image data (enlarged image data), which will be described later.

The controller 11 causes the colorimetry section 23 to perform colorimetry on the print product (color adjustment image) printed by the printing section 22.

The controller 11 performs color adjustment on the printing section 22 on the basis of a colorimetry result by the colorimetry section 23. That is, the controller 11 functions as a color adjustment means.

The reference color in the color adjustment (color matching) may be a standard color or a color of a color sample specified by a customer.

The standard color is DIC Color®, PANTONE®, or the like.

The color sample is used, for example, to specify a color of a corporate color, a logo mark, or the like.

Specifically, the controller 11 calculates how much the color obtained by the colorimetry deviates from the reference color. The controller 11 calculates how to adjust each of the CMYK color components for the printing section 22 to perform printing in the color of the reference color. The controller 11 writes the color adjustment result into the LUT 251 of the storage section 25 of the printer 20.

The controller 11 determines whether a predetermined area in the image data to be printed satisfies the colorimetry area condition of the colorimetry section 23. The image data to be printed is image data for printing a final product. For example, the image data to be printed is image data that a customer has requested to print. The predetermined area may be an automatically extracted area or an area specified by the user.

Satisfying the colorimetry area condition means, for example, that the size of the colorimetry target area of the print product is equal to or larger than the aperture size of the colorimetry section 23. The aperture size is the colorimetry-performable minimum size of the colorimetry section 23.

As the “if a predetermined area in the image data to be printed satisfies the colorimetry area condition of the colorimetry unit 23”, the “if the size of an area in the print product printed based on the image data to be printed, the area corresponding to the predetermined area, is equal to or larger than the aperture size of the colorimetry section 23” is used.

If the predetermined area in the image data to be printed satisfies the colorimetry area condition of the colorimetry section 23, the controller 11 causes the colorimetry section 23 to perform colorimetry in a first mode. The first mode is a mode in which a print product identical with a print product that is actually used as a product is printed, and colorimetry is performed on this print product.

If the predetermined area in the image data to be printed does not satisfy the colorimetry area condition of the colorimetry section 23, the controller 11 causes the colorimetry section 23 to perform colorimetry in a second mode. The second mode is a mode in which a print product (alternative print product) that is not, itself, a print product that is actually used as a product is printed, and colorimetry is performed on this alternative print product.

That is, the controller 11 functions as a colorimetry control means.

In the first mode, the controller 11 causes the printing section 22 to perform printing based on the image data to be printed, and causes the colorimetry section 23 to perform colorimetry on an area in a print product printed based on the image data to be printed, the area corresponding to the predetermined area.

The controller 11 performs color adjustment on the printing section 22 on the basis of the colorimetry result of the area corresponding to the predetermined area.

In the second mode, the controller 11 generates second image data (patch-added image data) with a patch image(s) added to the image data to be printed.

The color of the patch image is the color of the predetermined area in the image data to be printed.

The controller 11 generates the patch image so as to satisfy the colorimetry area condition. Specifically, the controller 11 generates a patch image such that the size of an area in the print product printed based on the second image data, the area corresponding to the patch image, is equal to or larger than the aperture size of the colorimetry section 23.

In the second mode, when the controller 11 generates the second image data in the second mode, the controller 11 causes the printing section 22 to perform printing based on the second image data.

The controller 11 causes the colorimetry section 23 to perform colorimetry on the area in the print product printed based on the second image data, the area corresponding to the patch image.

The controller 11 performs color adjustment on the printing section 22 on the basis of the colorimetry result of the area corresponding to the patch image.

For example, in the second mode, in generating the second image data, the controller 11 adds the patch image to a margin portion of the image data to be printed. Here, the controller 11 adds the patch image to a margin portion in a direction in which printing unevenness is less between the main scanning direction and the sub-scanning direction in the printing section 22. It is assumed that the direction in which the printing unevenness is less between the main scanning direction and the sub-scanning direction is known, regarding the printer 20 to be used. Information on the direction (main scanning direction or sub-scanning direction) in which printing unevenness is less is stored in the storage section 15.

In the second mode, in generating the second image data, the controller 11 adds the patch image to the same position as the predetermined area of the image data to be printed. In this case, although the original “predetermined area” in image data does not satisfy the colorimetry area condition, adding the patch image having a size satisfying the colorimetry area condition in the same color as the “predetermined area” makes it possible to perform colorimetry using a print product that is similar to the actual product.

In the second mode, the controller 11 generates third image data (enlarged image data) by enlarging the image data to be printed. Here, the controller 11 sets the center position of the predetermined area of the image data to be printed as the center of enlargement. The controller 11 enlarges the image data such that the predetermined area satisfies the colorimetry area condition. Specifically, the controller 11 enlarges the image data to be printed such that the size of an area in the print product printed based on the third image data, the area corresponding to an enlarged predetermined area, is equal to or larger than the aperture size of the colorimetry section 23.

In the second mode, when the controller 11 generates the third image data, the controller 11 causes the printing section 22 to perform printing based on the third image data.

The controller 11 causes the colorimetry section 23 to perform colorimetry on the area in the print product printed based on the third image data, the area corresponding to the enlarged predetermined area.

The controller 11 performs color adjustment on the printing section 22 on the basis of the colorimetry result of the area corresponding to the enlarged predetermined area.

### <In Case of Automatically Extracting Area in Color Similar to Specified Color>

The controller 11 extracts, from the image data to be printed, an area(s) in a predetermined color range satisfying a colorimetry area condition. That is, the controller 11 functions as an extraction means.

The controller 11 presents the extracted area(s) to the user. That is, the controller 11 functions as a presentation means.

The controller 11 receives selection of an area by the user from among presented area(s). That is, the controller 11 functions as a receiving means.

In this case, the “predetermined area” in the image data to be printed is an area selected by the user from among the automatically extracted and presented area(s).

### <In Case of User Manually Specifying Area)

The controller 11 causes the display part 13 to display a thumbnail image based on the image data to be printed. That is, the controller 11 functions as a display control means.

The controller 11 receives specification of an area by the user on the thumbnail image. That is, the controller 11 functions as a receiving means.

In this case, the “predetermined area” in the image data to be printed is an area specified by the user.

The colorimetry target area of the print product is desirably a single-color area satisfying the colorimetry area condition. The single color is a color using only one of color components such as cyan, magenta, yellow, and black. For example, the single color of cyan is a color represented by a cyan color component of more than 0% but 100% or less.

It is desirable that the colorimetry target area of the print product be a solid (100%) area of the single color in particular.

For example, in the case where the user manually specifies an area, the controller 11 may receive specification of an area (frame) having some degree of extent on the thumbnail image by the user's operation on the operation part 12. The controller 11 may extract a single-color area satisfying the colorimetry area condition from the specified area.

If the size of the colorimetry target area of the print product is larger than the aperture size of the colorimetry section 23, the controller 11 causes the colorimetry section 23 to perform colorimetry at a plurality of points in the colorimetry target area. The controller 11 uses the average value of the colorimetry values at the plurality of points as the colorimetry result of the colorimetry target area.

### [Operation of Printing System]

Next, operation of the printing system 100 will be described.

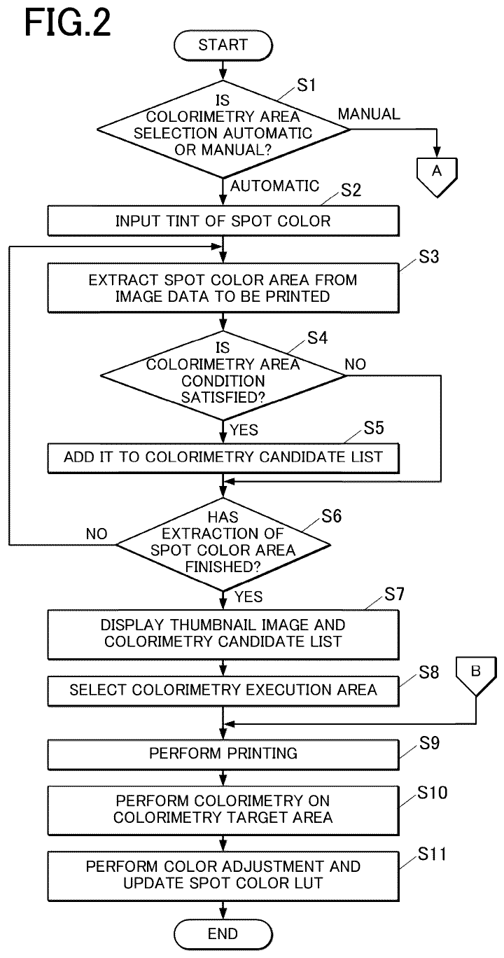

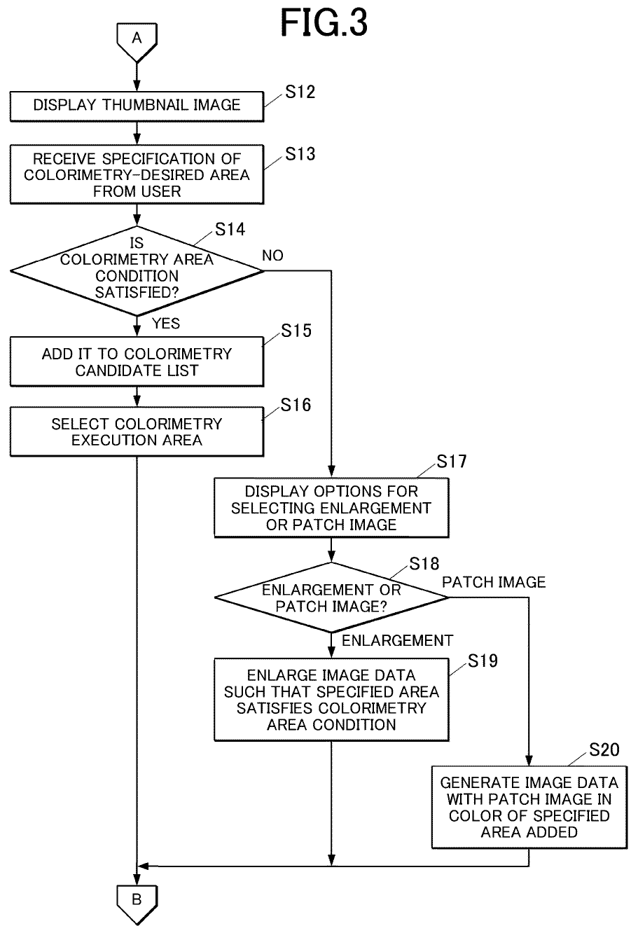

FIG. 2 and FIG. 3 are flowcharts showing the color adjustment process that is performed by the PC 10. In this embodiment, a process for obtaining device values (CMYK values) corresponding to a spot color for color matching of the spot color will be described as an example. The color adjustment process is archived by software processing by the controller 11 and the color management application program 151 working together.

First, the controller 11 of the PC 10 determines the setting of a colorimetry area selection method (Step S1). For example, the controller 11 determines which of “automatic” and “manual” is set as the colorimetry area selection method in setting information stored in the storage section 15. Alternatively, the controller 11 may display options of “automatic” and “manual” on the display part 13 for the user to choose.

If the colorimetry area selection method is set to “automatic” (Step S1; Automatic), the controller 11 receives input of the tint of a spot color (Step S2). The user operates the operation part 12 to input the tint (L*a*b* or the like) of a spot color to be subjected to color adjustment. The controller 11 acquires information on the input tint.

Next, the controller 11 extracts, from the image data to be printed, an area (spot color area) in a predetermined color range on the basis of the input tint (Step S3). For example, the controller 11 extracts an area having a color difference equal to or smaller than a threshold value with respect to the tint input by the user. In this way, the controller 11 extracts a spot color area with a certain degree of width (error). The predetermined color range may be specified by the user in Step S2.

Next, the controller 11 determines whether the extracted spot color area satisfies the colorimetry area condition (Step S4). Specifically, the controller 11 determines whether the size of the extracted spot color area is greater than or equal to the aperture size (smallest measurable size) of the colorimetry section 23.

If the spot color area satisfies the colorimetry area condition (Step S4: YES), the controller 11 adds this spot color area to a colorimetry candidate list (Step S5). Here, the spot color area added to the colorimetry candidate list corresponds to the “area satisfying the colorimetry area condition in the predetermined color range”.

After Step S5 or it is determined in Step S4 that the spot color area does not satisfy the colorimetry area condition (Step S4: NO), the process proceeds to Step S6. That is, if the spot color area does not satisfy the colorimetry area condition, the controller 11 does not add the spot color area to the colorimetry candidate list.

In Step S6, the controller 11 determines whether extraction of the spot color area from the image data to be printed has finished.

If it is determined that extraction of the spot color area has not finished (Step S6: NO), the process returns to Step S3.

If it is determined in Step S6 that extraction of the spot color area has finished (Step S6: YES), the controller 11 causes the display part 13 to display the thumbnail image of the image data to be printed and the colorimetry candidate list (Step S7).

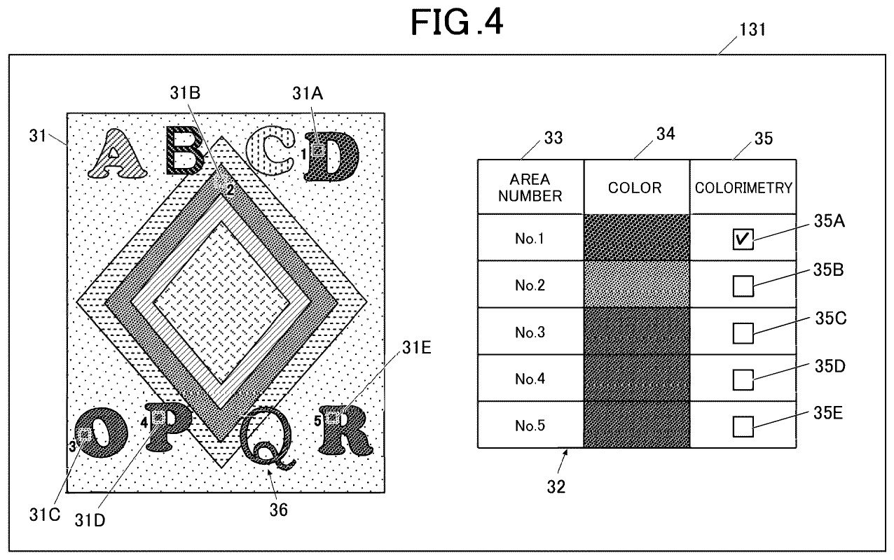

FIG. 4 shows an example of an automatic extraction result presentation screen 131 displayed by the display part 13. The automatic extraction result presentation screen 131 includes a thumbnail image area 31 and a colorimetry candidate list area 32.

In the thumbnail image area 31, the thumbnail image based on the image data to be printed is displayed. On the thumbnail image, automatically extracted spot color areas 31A to 31E are shown by rectangles. The spot color areas 31A to 31E are extracted as areas having colors (in the predetermined color range) approximate to the tint input in Step S2 and satisfying the colorimetry area condition.

In FIG. 4, for convenience, different patterns are used to show difference in color. The same applies to other drawings.

In the colorimetry candidate list area 32, a list of automatically extracted spot color areas (colorimetry candidates) is displayed. The colorimetry candidate list area 32 includes an area number field 33, a color field 34, and a colorimetry execution selection field 35.

In the area number field 33, the numbers No. 1 to No. 5 assigned to the respective spot color areas 31A to 31E in the thumbnail image area 31 are displayed. The area numbers No. 1 to No. 5 correspond to the spot color areas 31A to 31E, respectively. The controller 11 causes the display part 13 to display the area numbers corresponding to the respective areas in the vicinity of the respective spot color areas 31A to 31E in the thumbnail image area 31. This makes the correspondence between the spot color areas 31A to 31E and the area numbers No. 1 to No. 5 clear. Note that instead of causing the display part 13 to display the area numbers corresponding to the respective spot color areas 31A to 31E in the thumbnail image area 31 at all times, the controller 11 may cause the display part 13 to, in response to the mouse cursor brought close to the respective spot color areas 31A to 31E, display the area numbers corresponding to the respective areas.

The colors of the spot color areas 31A to 31E corresponding to the area numbers No. 1 to No. 5 are displayed in the color field 34.

The colorimetry execution selection field 35 includes checkboxes 35A to 35E for selecting the spot color areas 31A to 31E corresponding to the area numbers No. 1 to No. 5 as a colorimetry execution area(s).

In the automatic extraction result presentation screen 131 shown in FIG. 4, a character 36 of “Q” displayed in the thumbnail image area 31 is thin, which cannot secure the aperture size of the colorimetry section 23. That is, the character 36 of “Q” is not listed as a colorimetry candidate because it does not satisfy the colorimetry area condition.

Next, the controller 11 receives selection of a colorimetry execution area (Step S8). The user operates the operation part 12 to select a colorimetry-desired colorimetry execution area on the colorimetry candidate list. To be specific, the user checks one of the checkboxes 35A to 35E provided in the colorimetry execution selection field 35 in the colorimetry candidate list area 32 of the automatic extraction result suggestion screen 131.

In the automatic extraction result presentation screen 131 shown in FIG. 4, the checkbox 35A corresponding to the area number No. 1 is checked. That is, the spot color area 31A extracted from the character “D” in the thumbnail image area 31 is selected. Regarding the currently selected spot color area 31A corresponding to the area number No. 1, a rectangle is shown by a solid line in the thumbnail image area 31. Regarding the unselected spot color areas 31B to 31E corresponding to the area numbers No. 2 to No. 5, rectangles are shown by broken lines in the thumbnail image area 31.

The controller 11 acquires information on the selected colorimetry execution area.

Next, the controller 11 causes the printing section 22 of the printer 20 to perform printing based on the image data to be printed (Step S9). Specifically, the controller 11 transmits the image data to be printed to the printer 20 via the communication part 14.

The controller 21 of the printer 20 causes the printing section 22 to print a print product on the basis of the image data to be printed.

Next, the controller 11 of the PC 10 causes the colorimetry section 23 of the printer 20 to perform colorimetry on a colorimetry target area of the print product (Step S10). Specifically, the controller 11 transmits a colorimetry instruction including the colorimetry target area to the printer 20 via the communication part 14. Here, the colorimetry target area is an area in the print product after printing, the area corresponding to the colorimetry execution area selected in Step S8.

The controller 21 of the printer 20 causes the colorimetry section 23 to perform colorimetry on the colorimetry target area of the print product, on the basis of the colorimetry instruction. The colorimetry section 23 performs colorimetry on the colorimetry target area of the print product and generates colorimetric data. In the colorimetry, the controller 21 controls the colorimetry position of the print product in the sheet conveyance direction (sub-scanning direction) according to the timing at which the print product is conveyed to the colorimetry section 23. Meanwhile, the controller 21 controls the colorimetry position of the print product in the direction orthogonal to the sheet conveyance direction by moving the position of the colorimetry section 23 in the sheet width direction (main scanning direction). The controller 21 transmits the colorimetric data to the PC 10 via the communication part 24.

The controller 11 of the PC 10 acquires the colorimetric date of the colorimetry target area of the print product via the communication part 14.

Note that if the size of the colorimetry target area of the print product is larger than the aperture size of the colorimetry section 23, the controller 11 causes, in Step S10, the colorimetry section 23 to perform colorimetry at a plurality of points in the colorimetry target area. The controller 11 then uses the average value of the colorimetric values at the plurality of points as the colorimetry result of the colorimetry target area. For example, for the background portion or the like of an image, a relatively wide area can be set as the colorimetry target area.

Next, the controller 11 of the PC 10 performs color adjustment on the basis of the colorimetry result and updates an LUT for the spot color (Step S11).

Specifically, the controller 11 calculates how much the color obtained by colorimetry deviates from a reference color (a standard color, a color sample, or the like). The controller 11 calculates how to adjust the color components of CMYK in order that the printing section 22 perform printing in the color of the reference color (color adjustment). The controller 11 writes the color adjustment result in the LUT used in the printer 20, thereby updating the LUT. The controller 11 transmits the updated LUT to the printer 20 via the communication part 14.

The controller 21 of the printer 20 acquires the updated LUT from the PC 10 via the communication part 24 and stores the acquired LUT in the storage section 25, thereby updating the LUT 251 Thereafter, when the controller 21 receives a print instruction for the spot color, the controller 21 converts the spot color into CMYK values using the updated LUT 251 and performs printing using the CMYK values.

In Step S1, if the colorimetry area selection is set to “manual” (Step S1; Manual), the process proceeds to Step S12 in FIG. 3. For example, if an area of a spot color that a user wants to set as a color adjustment target is already determined and accordingly it is not necessary to automatically extract a colorimetry area. “manual” is set.

In Step S12, the controller 11 causes the display part 13 to display a thumbnail image of the image data to be printed.

Next, the controller 11 receives specification of an area on the thumbnail image, the area being desired by the user on which colorimetry is performed (Step S13). The user operates the operation part 12 to specify a colorimetry-desired area on the thumbnail image. The controller 11 acquires information on the specified area.

Next, the controller 11 determines whether the specified area satisfies the colorimetry area condition (Step S14). Specifically, the controller 11 determines whether the size of the specified area is equal to or larger than the aperture size (colorimetry-performable minimum size) of the colorimetry section 23.

If the specified area satisfies the colorimetry area condition (Step S14: YES), the controller 11 adds this area to the colorimetry candidate list (Step S15).

Next, the controller 11 receives selection of a colorimetry execution area (Step S16). The user operates the operation part 12 to select a colorimetry execution area on the colorimetry candidate list.

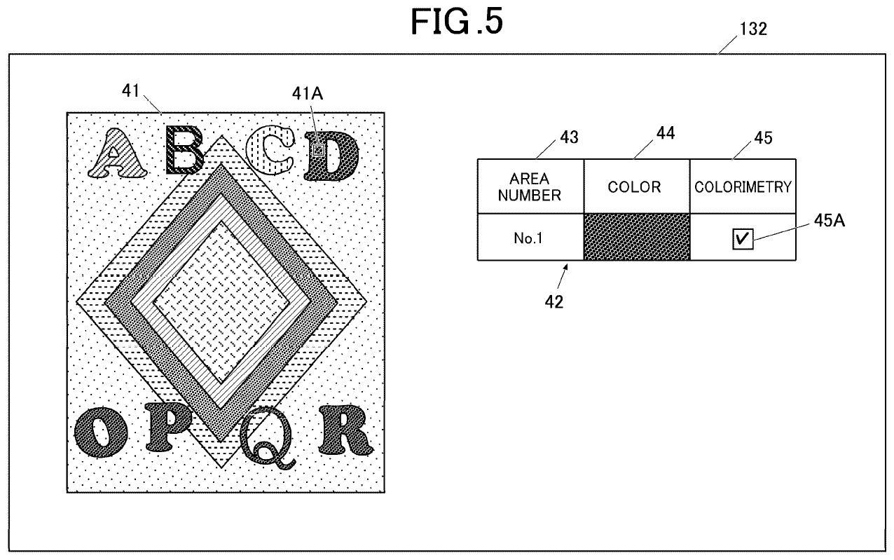

FIG. 5 shows an example of a colorimetry area specification screen 132 displayed by the display part 13. The colorimetry area specification screen 132 includes a thumbnail image area 41 and a colorimetry candidate list area 42.

In the thumbnail image area 41, a thumbnail image based on the image data to be printed is displayed. The user operates the operation part 12 to specify a colorimetry-desired area on the thumbnail image. In FIG. 5, in the thumbnail image area 41, a colorimetry area 41A is specified on the character “D”. The colorimetry area 41A satisfies the colorimetry area condition that it is equal to or larger than the aperture size of the colorimetry section 23.

In the colorimetry candidate list area 42, a list of areas manually specified by the user is displayed. The colorimetry candidate list area 42 includes an area number field 43, a color field 44, and a colorimetry execution selection field 45.

The number No. 1 assigned to the manually specified colorimetry area 41A is displayed in the area number field 43.

The color of the colorimetry area 41A is displayed in the color field 44.

The colorimetry execution selection field 45 is provided with a checkbox 45A for selecting the colorimetry area 41A as the colorimetry execution area.

In the colorimetry area specification screen 132 shown in FIG. 5, the checkbox 45A is checked. That is, the colorimetry area 41A is selected as the colorimetry execution area.

After Step S16, the process proceeds to Step S9 in FIG. 2. The processes in Steps S9 to S11 are as described above. Provided that the colorimetry target area in Step S10 is an area corresponding to the colorimetry execution area selected in Step S16 (area specified in Step S13) in the print product after printing.

In Step S14, if the specified area does not satisfy the colorimetry area condition (Step S14: NO), the controller 11 causes the display part 13 to display options for selecting enlargement or a patch image (Step S17). That is, the controller 11 presents an alternative colorimetry method.

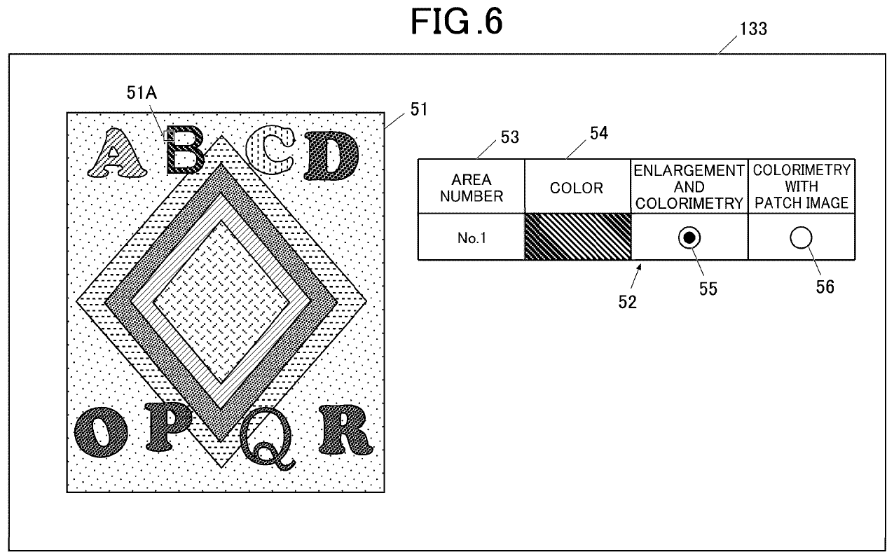

FIG. 6 shows an example of a colorimetry method selection screen 133 displayed by the display part 13. The colorimetry method selection screen 133 includes a thumbnail image area 51 and an option area 52.

In the thumbnail image area 51, a thumbnail image based on the image data to be printed is displayed. The user operates the operation part 12 to specify a colorimetry-desired area on the thumbnail image. In FIG. 6, in the thumbnail image area 51, a colorimetry area 51A is specified on the character “B”. The colorimetry area 51A does not satisfy the colorimetry area condition that it is equal to or larger than the aperture size of the colorimetry section 23. Therefore, the colorimetry area 51A itself cannot be subjected to colorimetry.

Note that in FIG. 6, the rectangle representing the colorimetry area 51A is drawn so as to protrude from the letter “B” so that it is easy to understand that the colorimetry area condition is not satisfied.

The option area 52 includes an area number field 53, a color field 54, and radio buttons 55, 56.

The number No. 1 assigned to the manually specified colorimetry area 51A is displayed in the area number field 53.

The color of the colorimetry area 51A is displayed in the color field 54.

The radio button 55 is a button for selecting “enlargement and colorimetry” as an alternative colorimetry method.

The radio button 56 is a button for selecting “colorimetry with patch image” as an alternative colorimetry method.

The user operates the operation part 12 to select one of the options of “enlargement and colorimetry” or “colorimetry with patch image” on the colorimetry method selection screen 133. Specifically, the user selects one of the radio buttons 55, 56.

The controller 11 determines which of “enlargement and colorimetry” and “colorimetry with patch image” has been selected by the user (Step S18).

If “enlargement and colorimetry” is selected (Step S18: Enlargement), the controller 11 enlarges the image data such that the specified area satisfies the colorimetry area condition (Step S19).

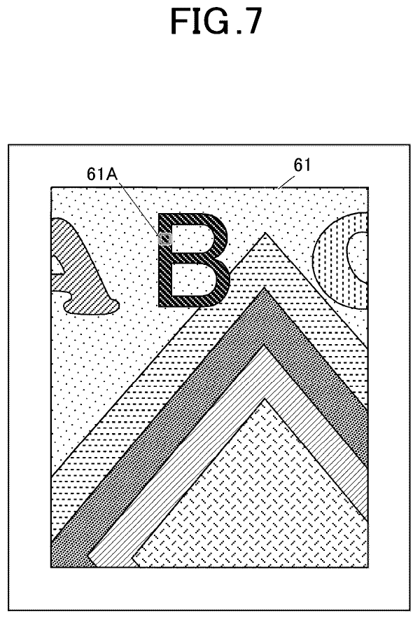

FIG. 7 shows an example of third image data (enlarged image data) 61 obtained by enlarging the image data to be printed with the specified area as the center.

In the third image data 61, an area 61A obtained by enlarging the specified area has a size satisfying the colorimetry area condition.

After Step S19, the process proceeds to Step S9 in FIG. 2.

In Step S9, the controller 11 causes the printing section 22 of the printer 20 to perform printing based on the third image data (enlarged image data). Specifically, the controller 11 transmits the third image data to the printer 20 via the communication part 14.

The controller 21 of the printer 20 causes the printing section 22 to print a print product on the basis of the third image data.

Next, the controller 11 of the PC 10 causes the colorimetry section 23 of the printer 20 to perform colorimetry on the colorimetry target area of the print product printed based on the third image data (Step S10). Here, the colorimetry target area is an area corresponding to the enlarged specified area. Specifically, the controller 11 transmits a colorimetry instruction including the colorimetry target area to the printer 20 via the communication part 14.

The controller 21 of the printer 20 causes the colorimetry section 23 to perform colorimetry on the colorimetry target area of the print product, on the basis of the colorimetry instruction. The colorimetry section 23 performs colorimetry on the colorimetry target area of the print product and generates colorimetric data. The controller 21 transmits the colorimetric data to the PC 10 via the communication part 24.

The controller 11 of the PC 10 acquires the colorimetric data of the colorimetry target area of the print product (area corresponding to the enlarged specified area) via the communication part 14.

Next, the controller 11 of the PC 10 performs color adjustment on the basis of the colorimetry result of the area corresponding to the enlarged specified area, and updates the LUT for the spot color (Step S11).

If “colorimetry with patch image” is selected in Step S18 (Step S18: Patch Image), the controller 11 generates image data to which a patch image in the color of the specified area is added (Step S20).

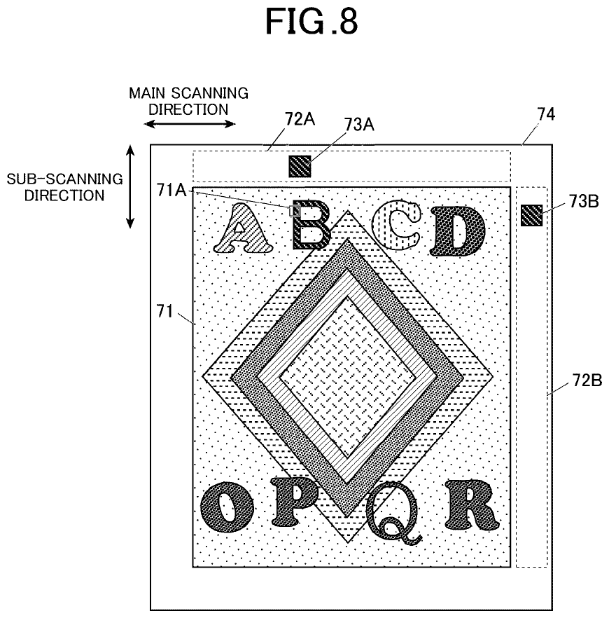

FIG. 8 shows an example of second image data (patch-added image data) 74 in which patch images 73A. 73B are added to margin portions 72A. 72B of image data 71 to be printed. The colors of the patch images 73A. 73B are the same as the color of the specified area 71A.

The controller 11 arranges the patch image 73A at the same position as the specified area 71A in the main scanning direction of the printing section 22 in the margin portion 72A of the image data 71 to be printed. Here, the controller 11 causes the center position of the patch image 73A in the main scanning direction to coincide with the center position of the specified area 71A.

The controller 11 arranges the patch image 73B at the same position as the specified area 71A in the sub-scanning direction of the printing section 22 in the margin portion 72B of the image data 71 to be printed. Here, the controller 11 causes the center position of the patch image 73B in the sub-scanning direction to coincide with the center position of the specified area 71A.

FIG. 8 shows the state in which the two patch images 73A. 73B are arranged, but the controller 11 may add one of the patch images 73A. 73B to the image data 71.

For example, the controller 11 adds a patch image to a margin portion in a direction less influenced by printing unevenness between the main scanning direction and the sub-scanning direction in the printing section 22.

Further, the controller 11 may add a patch image to any area specified by the user.

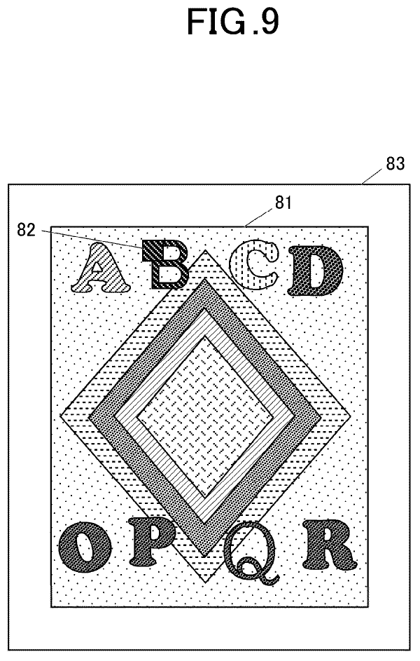

FIG. 9 shows an example of second image data (patch-added image data) 83 in which a patch image 82 in the color of the specified area is added at the same position as the specified area of image data 81 to be printed. Specifically, the patch image 82 is added onto the image data 81 such that the center position of the specified area specified on the character “B” and the center position of the patch image 82 coincide with each other.

Whether the controller 11 adds a patch image to a margin portion or to the same position as the specified area in adding a patch image(s) to the image data to be printed may be determined in advance.

Alternatively, when generating the second image data, the controller 11 may cause the user to select whether to add a patch image to the margin portion or the same position as the specified area.

After Step S20, the process proceeds to Step S9 in FIG. 2.

In Step S9, the controller 11 causes the printing section 22 of the printer 20 to perform printing based on the second image data (patch-added image data). Specifically, the controller 11 transmits the second image data to the printer 20 via the communication part 14.

The controller 21 of the printer 20 causes the printing section 22 to print a print product on the basis of the second image data.

Next, the controller 11 of the PC 10 causes the colorimetry section 23 of the printer 20 to perform colorimetry on the colorimetry target area of the print product printed based on the second image data (Step S10). Here, the colorimetry target area is an area corresponding to the patch image. Specifically, the controller 11 transmits a colorimetry instruction including the colorimetry target area to the printer 20 via the communication part 14.

The controller 21 of the printer 20 causes the colorimetry section 23 to perform colorimetry on the colorimetry target area of the print product, on the basis of the colorimetry instruction. The colorimetry section 23 performs colorimetry on the colorimetry target area of the print product and generates colorimetric data. The controller 21 transmits the colorimetric data to the PC 10 via the communication part 24.

The controller 11 of the PC 10 acquires the colorimetric data of the colorimetry target area of the print product (area corresponding to the patch image) via the communication part 14.

Next, the controller 11 of the PC 10 performs color adjustment on the basis of the colorimetry result of the area corresponding to the patch image, and updates the LUT for the spot color (Step S11).

This is the end of the color adjustment process.

As described above, according to the present embodiment, the controller 11 of the PC 10 causes the colorimetry section 23 to perform colorimetry in the first mode if a predetermined area in the image data to be printed (first image data) satisfies the colorimetry area condition of the colorimetry section 23. If the predetermined area in the image data to be printed does not satisfy the colorimetry area condition of the colorimetry section 23, the controller 11 causes the colorimetry section 23 to perform colorimetry in the second mode. Since the controller 11 changes the colorimetry method between the case where the colorimetry area condition is satisfied and the case where the colorimetry area condition is not satisfied, it is possible to accurately perform color adjustment even if the colorimetry area condition is not satisfied.

In the first mode, the controller 11 causes the printing section 22 to perform printing based on the image data to be printed, and causes the colorimetry section 23 to perform colorimetry on an area in a print product printed based on the image data to be printed, the area corresponding to the predetermined area. The controller 11 performs color adjustment on the printing section 22 on the basis of the colorimetry result of the area corresponding to the predetermined area. If the predetermined area satisfies the colorimetry area condition, the controller 11 uses the result of the colorimetry performed at the actual printing position with the actual print content, thereby being able to perform accurate color adjustment.

In the second mode, the controller 11 generates second image data (patch-added image data) with a patch image(s) in the color of the predetermined area satisfying the colorimetry area condition added to the image data to be printed. The controller 11 causes the printing section 22 to perform printing based on the second image data, and causes the colorimetry section 23 to perform colorimetry on an area in the print product printed based on the second image data, the area corresponding to the patch image. The controller 11 performs color adjustment on the printing section 22 on the basis of the colorimetry result of the area corresponding to the patch image. If the predetermined area does not satisfy the colorimetry area condition, the controller 11 can perform colorimetry satisfying the colorimetry area condition by using the patch image in the color of the predetermined area.

For example, in generating the second image data in the second mode, the controller 11 adds the patch image to a margin portion of the image data to be printed. Thus, the controller 11 can perform color adjustment while causing actual print contents to be printed.

In particular, the controller 11 adds the patch image to a margin part in a direction in which printing unevenness is less between the main scanning direction and the sub-scanning direction in the printing section 22. Accordingly, the controller 11 can exclude the influence of printing unevenness as much as possible from the colorimetry result of the area corresponding to the patch image.

Further, in generating the second image data in the second mode, the controller 11 adds the patch image to the same position as the predetermined area of the image data to be printed. Thus, the colorimetry section 23 can perform colorimetry by using a print product similar to an actual product. Since the controller 11 uses the result of colorimetry performed at a position where a predetermined area is actually printed, it is possible to perform color adjustment with high accuracy.

In the second mode, the controller 11 generates third image data (enlarged image data) with the image data to be printed enlarged such that the predetermined area satisfies the colorimetry area condition. The controller 11 causes the printing section 22 to perform printing based on the third image data, and causes the colorimetry section 23 to perform colorimetry on an area in the print product printed based on the third image data, the area corresponding to the enlarged predetermined area. The controller 11 performs color adjustment on the printing section 22 on the basis of the colorimetry result of the area corresponding to the enlarged predetermined area. Thus, the controller 11 can perform colorimetry satisfying the colorimetry area condition by enlarging the image data to be printed if the predetermined area does not satisfy the colorimetry area condition.

The controller 11 extracts, from the image data to be printed, an area(s) in a predetermined color range, the area satisfying the colorimetry area condition. The controller 11 presents an automatically extracted area(s) to the user, and allows the user to select one of the areas. This makes it easy to set the colorimetry target area.

The controller 11 causes the display part 13 to display a thumbnail image based on the image data to be printed, and allows the user to specify an area on the thumbnail image. This allows the user to specify an area as the colorimetry target area.

Further, the controller 11 can perform color adjustment using an area with little color unevenness by sets a single color area satisfying the colorimetry area condition as the colorimetry target area of the print product.

In particular, the controller 11 can reduce the influence of the color unevenness on the color adjustment by setting a solid (100%) area of the single color as the colorimetry target area.

Further, the colorimetry section 23 is configured to be movable in a direction (main scanning direction) orthogonal to the conveyance direction (sub-scanning direction) of the print product with respect to the print product being conveyed. Therefore, the colorimetry section 23 can easily perform colorimetry on the entire surface of the print product.

If the size of the colorimetry target area of the print product is larger than the aperture size of the colorimetry section 23, the controller 11 causes the colorimetry section 23 to perform colorimetry at a plurality of points in the colorimetry target area, and uses the average value of the colorimetric values at the plurality of points as the colorimetry result of the colorimetry target area. Thus, the controller 11 can obtain the stable colorimetry result(s).

Note that the descriptions in the above embodiment are examples of the printing system, the colorimetry control method, and the storage medium storing the program according to the present invention, and the present invention is not limited thereto. The detailed configuration and detailed operation of each device constituting the system can also be appropriately changed without departing from the scope of the present invention.

For example, in the above-described embodiment, the color adjustment target is a spot color, but the present invention is not limited thereto. Any color may be used as the color to be adjusted.

In the above embodiment, the printing system 100 includes the PC 10 in which the color management application program 151 is installed and the printer 20. Alternatively, the printer 20 may have the function of the color management application.

Further, in generating second image data with a patch image(s) added to a margin portion of the image data to be printed in the second mode, the controller 11 of the PC 10 may adjust the position at which the patch image is added, according to the printing method of the printing section 22.

For example, in the case where the printing section 22 adopts an electrophotographic method, it is desirable that the controller 11 makes the position at which the patch image is added the same as the position of the predetermined area (e.g., area specified by the user) in the main scanning direction.

Meanwhile, in the case where the printing section 22 adopts an inkjet method in which a print head moves in the main scanning direction to eject ink, printing unevenness (position unevenness) in the main scanning direction is negligible. Therefore, the controller 11 does not need to make the position of the patch image in the main scanning direction the same as the position of the predetermined area (e.g., area specified by the user).

Further, the controller 11 may set priorities to positions at which the patch image is added in accordance with the printing method of the printing section 22.

In the above-described embodiment, the colorimetry area condition of the colorimetry section 23 (colorimetry unit) is that the size of the colorimetry target area of the print product is equal to or larger than the aperture size of the colorimetry section 23. In place of that the colorimetric data being likely to have noise due to the influence of the color around the colorimetry target area may be set as a case where the colorimetry area condition is not satisfied. For example, if an area in a color corresponding to a complementary color of a certain color exists in the vicinity of the certain color, noise is likely to appear in the colorimetric data. The complementary color is a combination of colors that are in a relationship of being positioned exactly opposite in a hue circle.

In the above described embodiment, the colorimetry section 23 of the printer 20 is configured to be movable, with respect to the print product being conveyed, in the direction (main scanning direction) orthogonal to the conveyance direction of the print product, thereby being able to perform colorimetry on the entire surface of the print product. In place of that, the colorimetry section 23 may be configured by a line sensor provided over the direction (main scanning direction) orthogonal to the conveyance direction of the print product.

The computer-readable medium that stores the program for executing each process is not limited to the above-described example. A carrier wave may be used as a medium for providing data of the program via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. A printing system comprising:
a printing section;
a colorimetry unit capable of colorimetry on an entire surface of a print product printed by the printing section; and
a hardware processor that performs color adjustment on the printing section based on a colorimetry result by the colorimetry unit,
wherein the hardware processor,
in response to a predetermined area in first image data to be printed satisfying a colorimetry area condition of the colorimetry unit, causes the colorimetry unit to perform colorimetry in a first mode, and
in response to the predetermined area not satisfying the colorimetry area condition, causes the colorimetry unit to perform colorimetry in a second mode.

2. The printing system according to claim 1, wherein the hardware processor,
in the first mode, causes the printing section to perform printing based on the first image data, and causes the colorimetry unit to perform colorimetry on an area in the print product printed based on the first image data, the area corresponding to the predetermined area, and
performs color adjustment on the printing section based on the colorimetry result of the area corresponding to the predetermined area.

3. The printing system according to claim 1, wherein the hardware processor,
in the second mode, generates second image data with a patch image in a color of the predetermined area added to the first image data, the patch image satisfying the colorimetry area condition, causes the printing section to perform printing based on the second image data, and causes the colorimetry unit to perform colorimetry on an area in the print product printed based on the second image data, the area corresponding to the patch image, and
performs color adjustment on the printing section based on the colorimetry result of the area corresponding to the patch image.

4. The printing system according to claim 3, wherein in generating the second image data in the second mode, the hardware processor adds the patch image to a margin portion of the first image data in a main scanning direction or a sub-scanning direction in the printing section, whichever printing unevenness is less.

5. The printing system according to claim 3, wherein in generating the second image data in the second mode, the hardware processor adds the patch image at a position same as the predetermined area of the first image data.

6. The printing system according to claim 1, wherein the hardware processor,
in the second mode, generates third image data with the first image data enlarged such that the predetermined area satisfies the colorimetry area condition, causes the printing section to perform printing based on the third image data, and causes the colorimetry unit to perform colorimetry on an area in the print product printed based on the third image data, the area corresponding to the enlarged predetermined area, and
performs color adjustment on the printing section based on the colorimetry result of the area corresponding to the enlarged predetermined area.

7. The printing system according to claim 1, wherein satisfying the colorimetry area condition is a size of a colorimetry target area of the print product being equal to or larger than an aperture size of the colorimetry unit.

8. The printing system according to claim 1,
wherein the hardware processor
extracts, from the first image data, at least one area in a predetermined color range satisfying the colorimetry area condition,
presents the extracted at least one area to a user, and
receives selection of an area by the user from among the presented at least one area, and
wherein the predetermined area is the selected area.

9. The printing system according to claim 1,
wherein the hardware processor
causes a display part to display a thumbnail image based on the first image data, and
receives specification of an area by a user on the thumbnail image, and
wherein the predetermined area is the specified area.

10. The printing system according to claim 1, wherein a colorimetry target area of the print product is a single-color area satisfying the colorimetry area condition.

11. The printing system according to claim 1, wherein the colorimetry unit
is movable, with respect to the print product being conveyed, in a direction orthogonal to a conveyance direction of the print product, and
performs colorimetry on a colorimetry target area of the print product.

12. The printing system according to claim 1, wherein in response to a size of a colorimetry target area of the print product being larger than an aperture size of the colorimetry unit, the hardware processor causes the colorimetry unit to perform colorimetry at a plurality of points in the colorimetry target area, and uses an average value of colorimetric values at the plurality of points as the colorimetry result of the colorimetry target area.

13. A colorimetry control method that is performed by a computer of a printing system including a printing section and a colorimetry unit capable of colorimetry on an entire surface of a print product printed by the printing section, the computer performing color adjustment on the printing section based on a colorimetry result by the colorimetry unit, comprising:
in response to a predetermined area in first image data to be printed satisfying a colorimetry area condition of the colorimetry unit, causing the colorimetry unit to perform colorimetry in a first mode, and
in response to the predetermined area not satisfying the colorimetry area condition, causing the colorimetry unit to perform colorimetry in a second mode.

14. A non-transitory computer-readable storage medium storing a program that causes a computer of a printing system including a printing section and a colorimetry unit capable of colorimetry on an entire surface of a print product printed by the printing section, the computer performing color adjustment on the printing section based on a colorimetry result by the colorimetry unit, to perform:
in response to a predetermined area in first image data to be printed satisfying a colorimetry area condition of the colorimetry unit, causing the colorimetry unit to perform colorimetry in a first mode; and
in response to the predetermined area not satisfying the colorimetry area condition, causing the colorimetry unit to perform colorimetry in a second mode.
